(19) United States
(12) Patent Application Publication
(10) Pub. No.: US 2026/0357639 A1
(43) Pub. Date: Nov. 12, 2026

(54) WINDOW FRAME ASSEMBLY WITH REMOVABLE SNAP-IN J-CHANNEL

(71) Applicant: Owen Woodruff Bunker, II, Denver, CO (US)

(72) Inventor: Owen Woodruff Bunker, II, Denver, CO (US)

(21) Appl. No.: 19/672,156

(22) Filed: May 8, 2026

Related U.S. Application Data
(60) Provisional application No. 63/803,125, filed on May 9, 2025.

(51) Int. Cl. E06B 1/62; E06B 7/14

(52) U.S. Cl. CPC E06B 1/62; E06B 7/14; E06B 2001/628; E06B 2007/145

(57) ABSTRACT

A window assembly may include a frame and a J-channel removably couplable to the frame. The J-channel may include a plurality of J-channel members interconnected to define a perimeter that corresponds to a shape of a window. Each of the plurality of J-channel members may include: a structure-facing surface configured to be oriented toward a structure, a frame attachment flange extending from an inner edge of the structure-facing surface and in a generally perpendicular direction relative to the structure-facing surface, and a plurality of snap-lock protrusions spaced along an inner surface of the frame attachment flange. The plurality of snap-lock protrusions may be configured to be received by the frame for removable snap-fit coupling of the J-channel to the frame.

### CROSS-REFERENCE TO RELATED APPLICATIONS

This application claims benefit of U.S. Provisional Application No. 63/803,125, entitled “WINDOW FRAME ASSEMBLY WITH REMOVABLE SNAP-IN J-CHANNEL,” filed May 9, 2025, the contents of which are incorporated herein by reference in their entirety.

### FIELD

This invention relates generally to window frame assemblies, and more specifically, to window frame assemblies with one or more removable snap-in J-channels.

### BACKGROUND

J-channels are commonly used in window frame assemblies for both functional and aesthetic purposes. For instance, J-channels can be designed to secure the edges of siding materials, such as vinyl, while providing a weatherproof seal and accommodating the natural expansion and contraction of siding due to temperature changes. J-channels can also help redirect water away from openings, reducing the risk of moisture intrusion and protecting the structural integrity of the building.

J-channels are typically permanently fixed to the exterior perimeter of the window frame or surrounding structure using nails, screws, or adhesives. Siding panels are then slid into the J-channel's groove, where they are held securely in place. However, while this approach can provide a durable, weather-resistant seal and seamless integration with the siding, the permanent nature of conventional J-channel installations poses challenges when modifications or repairs are needed. For instance, removing or replacing conventional J-channels often requires significant effort, including detaching portions of the surrounding siding. Additionally, the sequence of installation—where the J-channel is affixed first, followed by the siding—limits flexibility and can complicate retrofitting or adapting the design to non-standard window openings or unconventional building environments.

Conventional J-channels are further limited as they are typically designed for a specific thickness of siding, and do not allow for adjustments to accommodate variations in siding thickness. For instance, once a J-channel is installed, the dimensions of the J-channel's groove are fixed, leaving no room for modifications to fit siding that is thinner or thicker than what the J-channel was originally designed for. This limitation can create significant challenges during renovations, retrofits, or repairs involving different siding materials, as the existing J-channel may no longer provide a proper fit or secure hold. Without the ability to adjust for varying siding thicknesses, the existing J-channels may need to be removed or replaced entirely, further complicating the process.

This can be particularly problematic in certain applications, such as shed windows or similar applications involving pre-assembled structures, where walls are often constructed before windows are installed. This lack of flexibility in J-channel designs can make it difficult to integrate windows into these structures, especially when dealing with non-standard window sizes or unique framing configurations.

### SUMMARY

Some embodiments of the present invention relate to window assemblies. The window assemblies may include a frame. The frame may include a plurality of frame members interconnected to define a perimeter around a window. Each of the plurality of frame members may include an inner surface configured to be oriented toward the window, an outer surface opposing the inner surface, a structure-facing surface configured to be oriented toward a structure, and an exterior-facing surface opposing the structure-facing surface and configured to be orientated toward an exterior environment. The frame may include a plurality of retention features spaced along at least one of the inner surface or the outer surface of at least one of the plurality of frame members. The window assemblies may include a J-channel removably couplable to the frame. The J-channel may include a structure-facing surface configured to be oriented toward the structure. The J-channel may include a frame attachment flange extending from and generally perpendicular to the structure-facing surface. The J-channel may include a plurality of engagement features spaced along the frame attachment flange. The plurality of engagement features may be configured to be received by the plurality of retention features for removable snap-fit coupling of the J-channel to the frame.

In some embodiments, spacing of the plurality of retention features may correspond to variations in a siding thickness.

In some embodiments, the frame may further include a drainage channel flange extending outwardly from and generally perpendicular to the exterior-facing surface of at least one of the plurality of frame members. The frame may further include a drainage channel defined by an inner surface of the drainage channel flange, at least a portion of the exterior-facing surface of at least one of the plurality of frame members, and at least a portion of the outer surface of at least one of the plurality of frame members. The plurality of retention features may be spaced along an inner surface of the drainage channel.

In some embodiments, the frame further may further include at least one drainage hole formed in the drainage channel flange of at least one of the plurality of frame members.

In some embodiments, the plurality of retention features may be spaced along at least a portion of the outer surface of at least one of the plurality of frame members, and the plurality of engagement features may be spaced along at least a portion of an inner surface of the frame attachment flange. The inner surface of the frame attachment flange may be configured to be oriented toward the window.

In some embodiments, the plurality of engagement features may include a plurality of hooks.

In some embodiments, the plurality of retention features may include rachet teeth.

In some embodiments, the frame attachment flange of the J-channel may extend from an inner edge of the structure-facing surface. The inner edge of the structure-facing surface may be configured to be proximate the window.

In some embodiments, the frame attachment flange of the J-channel may extend along a portion of the inner edge of the structure-facing surface.

In some embodiments, the plurality of engagement features may include a first hook and a second hook. The first hook may be formed at a structure-facing end of the frame attachment flange. The structure-facing end may be configured to be oriented toward the structure. The second hook may be disposed on an inner surface of the frame attachment flange. The inner surface of the frame attachment flange may be configured to be oriented toward the window.

In some embodiments, the frame may include a plurality of drainage channel flanges. Each of the plurality of drainage channel flanges may extend outwardly from and generally perpendicular to the exterior-facing surface of a corresponding frame member of the plurality of frame members. The plurality of drainage channel flanges may be arranged to correspond to a shape of the perimeter. The drainage channel may be defined by an inner surface of the plurality of drainage channel flange, at least a portion of the exterior-facing surface of the plurality of frame members, and at least a portion of the outer surface the plurality of frame members.

In some embodiments, adjacent ends of the plurality of drainage channel flanges at respective corners of the frame may be spaced to form a plurality of gaps. Each of the plurality of gaps may at least define a drainage hole.

Some embodiments of the present invention relate to J-channels for windows. The J-channels may include a plurality of J-channel members interconnected to define a perimeter that corresponds to a shape of a window. Each of the plurality of J-channel members may include a structure-facing surface configured to be oriented toward a structure. Each of the plurality of J-channel members may include a frame attachment flange extending from an inner edge of the structure-facing surface and in a generally perpendicular direction relative to the structure-facing surface. The inner edge of the structure-facing surface may be configured to be proximate the window. Each of the plurality of J-channel members may include a plurality of snap-lock protrusions that may be spaced along an inner surface of the frame attachment flange. The inner surface of the frame attachment flange may be configured to be oriented towards the window. The plurality of snap-lock protrusions may be configured to be received by a frame of the window for removable snap-fit coupling of the J-channel to the frame.

In some embodiments, spacing of the plurality of snap-lock protrusions on the inner surface of the frame attachment flange may correspond to variations in a siding thickness.

In some embodiments, the plurality of snap-lock protrusions may include at least one of a hook, a tab, a flange, a ridge, or a combination thereof.

In some embodiments, the frame attachment flange may extend along a portion of the inner edge of the structure-facing surface.

In some embodiments, adjacent ends of the frame attachment flange of the plurality of J-channel members may be spaced to form a plurality of gaps. Each of the plurality of gaps may at least partially defining a drainage hole.

In some embodiments, the plurality of snap-lock protrusions may include a first hook and a second hook. The first hook may be formed at a structure-facing end of the frame attachment flange. The structure-facing end may be configured to be oriented toward the structure. The second hook may be disposed on the inner surface of the frame attachment flange.

In some embodiments, each of the plurality of J-channel members may further include a siding cover flange. The siding cover flange may include the structure-facing surface and the inner edge.

In some embodiments, the siding cover flange may be configured to secure and at least partially cover siding positioned between the structure-facing surface and the frame.

In some embodiments, the siding cover flange may be configured to flex during siding installation and contract to securely retain siding positioned between the structure-facing surface and the frame.

Some embodiments of the present invention relate to frames for windows. The frames may include a plurality of frame members interconnected to define a perimeter around a window. Each of the plurality of frame members may include an inner surface configured to be oriented toward the window, an outer surface opposing the inner surface, a structure-facing surface configured to be oriented toward a structure, and an exterior-facing surface opposing the structure-facing surface and configured to be orientated toward an exterior environment. The frames may include a plurality of retention features spaced along at least one of the inner surface or the outer surface of at least one of the plurality of frame members.

In some embodiments, spacing of the plurality of retention features may correspond to variations in a siding thickness.

In some embodiments, the frames may further include a drainage channel flange extending outwardly from and generally perpendicular to the exterior-facing surface of at least one of the plurality of frame members. The frames may further include a drainage channel defined by an inner surface of the drainage channel flange, at least a portion of the exterior-facing surface of at least one of the plurality of frame members, and at least a portion of the outer surface of at least one of the plurality of frame members. The plurality of retention features may be spaced along an inner surface of the drainage channel.

In some embodiments, at least one drainage hole may be formed in at least one of the plurality of frame members.

In some embodiments, the plurality of retention features may include rachet teeth.

In some embodiments, the frame may include a plurality of drainage channel flanges. Each of the plurality of drainage channel flanges may extend outwardly from and generally perpendicular to the exterior-facing surface of a corresponding frame member of the plurality of frame members. The plurality of drainage channel flanges may be arranged to correspond to a shape of the perimeter. The drainage channel may be defined by an inner surface of the plurality of drainage channel flange, at least a portion of the exterior-facing surface of the plurality of frame members, and at least a portion of the outer surface the plurality of frame members.

In some embodiments, adjacent ends of the plurality of drainage channel flanges at respective corners of the frame may be spaced to form a plurality of gaps. Each of the plurality of gaps may at least partially define a drainage hole.

### BRIEF DESCRIPTION OF THE DRAWINGS

A further understanding of the nature and advantages of the disclosed technology may be realized by reference to the remaining portions of the specification and the drawings.

FIG. 1A is a perspective view of a window assembly with the J-channel uninstalled, according to some embodiments of the present invention.

FIG. 1B is a perspective view of the window assembly of FIG. 1A with the J-channel installed, according to some embodiments of the present invention.

FIG. 1C is a detail view of the frame and the J-channel of the window assembly of FIG. 1B, according to some embodiments of the present invention.

FIG. 1D-1F are cross-sectional views of the frame and the J-channel of the window assembly of FIG. 1B, according to some embodiments of the present invention.

### DETAILED DESCRIPTION

The subject matter of embodiments of the present invention is described here with specificity to meet statutory requirements, but this description is not necessarily intended to limit the scope of the claims. The claimed subject matter may be embodied in other ways, may include different elements or steps, and may be used in conjunction with other existing or future technologies. This description should not be interpreted as implying any particular order or arrangement among or between various steps or elements except when the order of individual steps or arrangement of elements is explicitly described.

Further, while embodiments of the present invention may be discussed in the context of shed windows, it should be appreciated that the claimed subject matter may be utilized in windows for a wide range of structures, including but not limited to residential structures (e.g., homes, apartment buildings), commercial structures (e.g., office buildings, retail stores), utility structures (e.g., barns, greenhouses, garages, workshops), recreational structures (e.g., campers), vehicles (e.g., boats, RVs, trailers, busses, trains), and/or other suitable structures.

Embodiments of the present invention are directed to window frame assemblies with one or more removable snap-in J-channels. The window frame assemblies may provide the solutions that simplify installation and/or maintenance of windows on a wide range of structures. For example, the window frame assemblies may include a J-channel removably couplable to a frame of the window frame assemblies. The J-channel may include one or more engagement features (e.g., snap-lock protrusions) that may be configured to engage with corresponding retention features (e.g., rachet teeth) of the frame for removable snap-fit coupling of the J-channel to the frame. The removable snap-fit coupling between the J-channel and the frame may provide a way of quickly and securely installing the J-channel, while also providing the option to remove the J-channel when needed. These features may also allow siding to be installed independently, with the J-channel snapped into place afterward, offering greater flexibility in construction.

Further, the engagement features (e.g., snap-lock protrusions) and/or the retention features (e.g., rachet teeth) may be spaced or otherwise configured to correspond to different thicknesses of siding, sheathing, and/or trim materials. For example, the window frame assemblies may include one or more engagement features and a plurality of retention features that are spaced to correspond to a variety of siding thicknesses. This may allow the J-channel to be pressed into the frame until one or more of the engagement features reaches a retention feature that allows the J-channel to sit flush with the surrounding siding. Because the J-channel is removable, the J-channel may be removed and re-installed to fit siding that is thinner or thicker than the original siding. This may allow for adjustments or modifications (e.g., renovations, retrofit) that involve siding materials of differing thicknesses.

In applications like sheds, for example, these features may provide the ability to quickly remove the J-channel for cleaning or inspecting the drainage channel, or to replace or adjust the trim without disturbing surrounding siding, thus aligning with the practical and low-maintenance needs of these structures. These features may also provide the ability for a single J-channel to be installed to fit a variety of different sheds with variations in siding, allowing for greater flexibility in installation and maintenance of these structures.

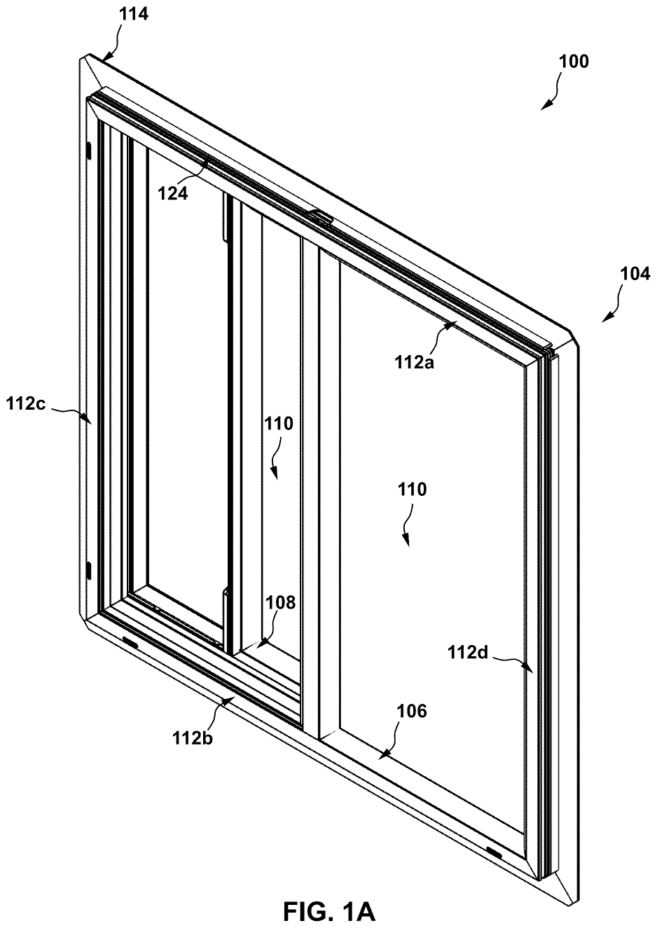

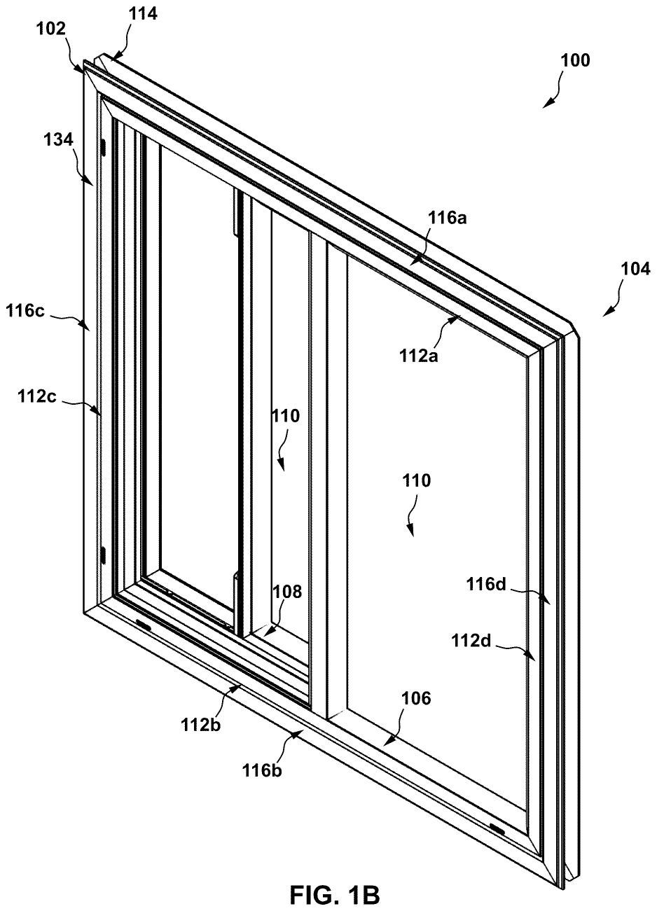

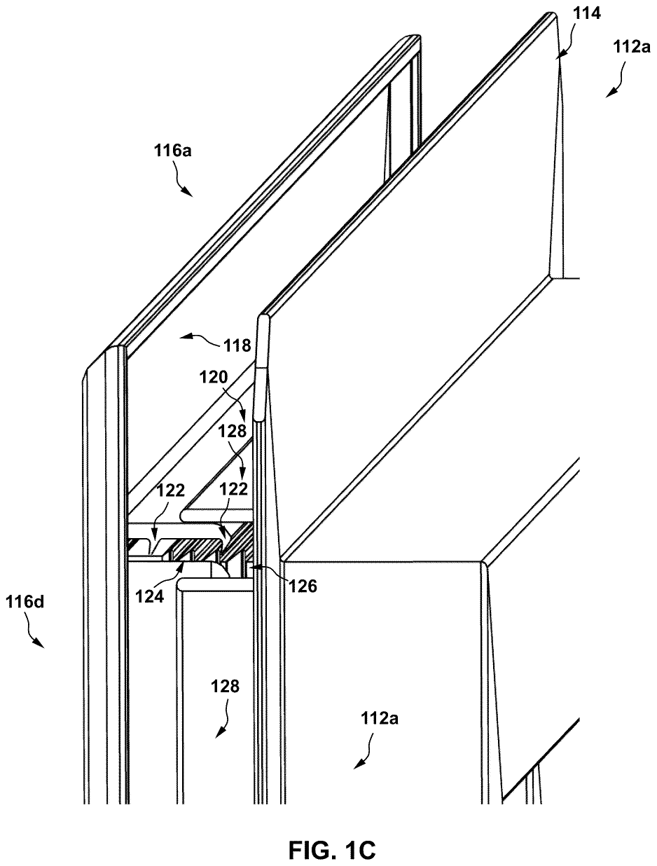

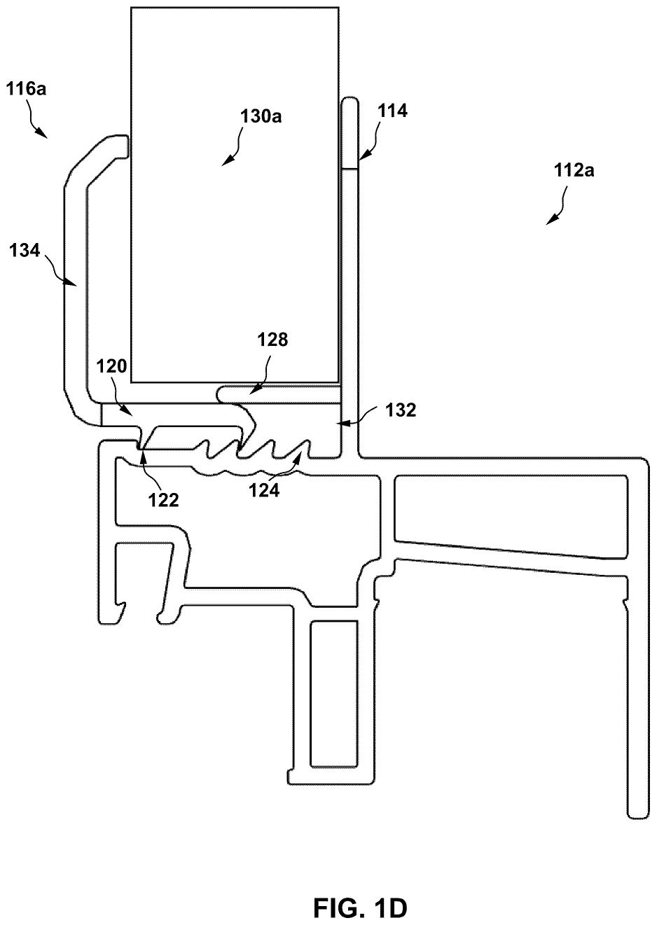

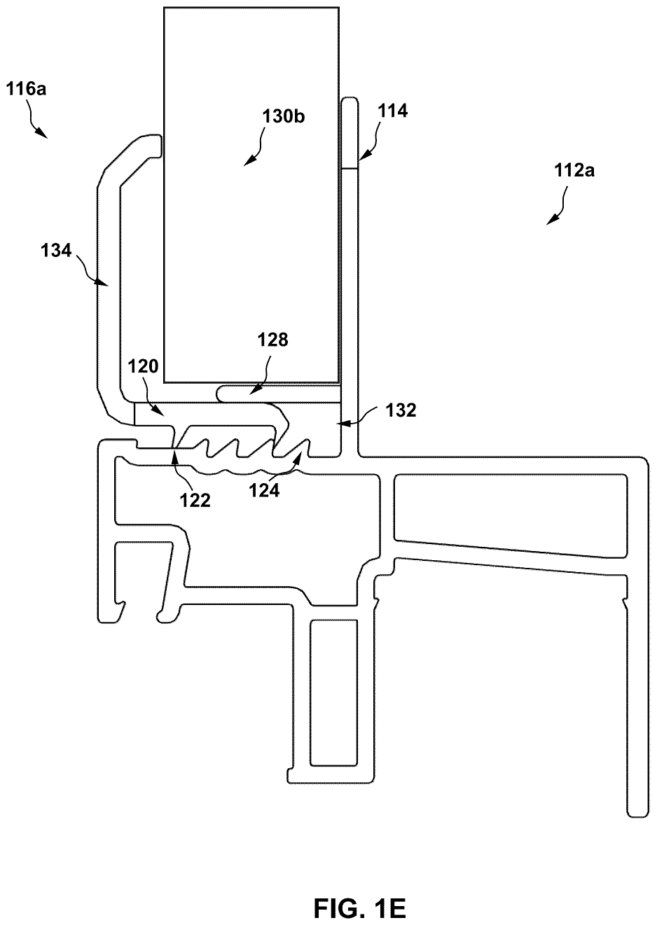

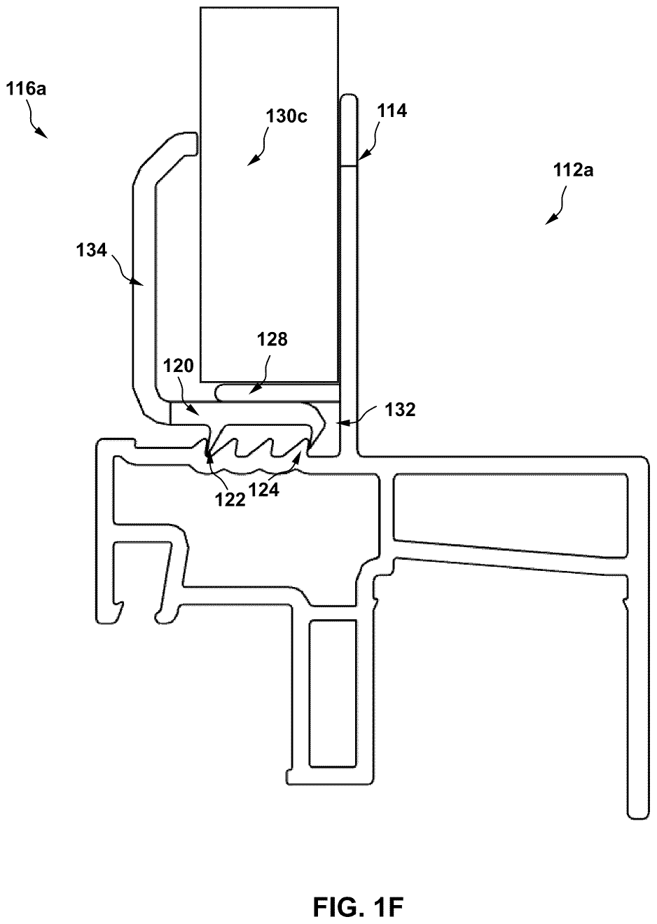

FIG. 1A depicts a perspective view of a window assembly 100 with the J-channel 102 (shown in FIG. 1B) uninstalled, according to some embodiments of the present invention. The window assembly 100 may by any suitable type of window, including but not limited to sliding windows (e.g., horizontal sliding windows, hung windows), casement windows, awning windows, hopper windows, fixed windows (e.g., picture windows), bay windows, bow windows, skylights, tilt-and-turn windows, or other suitable windows. Thus, while the window assembly 100 in FIGS. 1A-B is depicted as a horizontal sliding window, it should be appreciated that the window assembly 100 may include any suitable type of window, and such variations are also contemplated within the scope of the present invention.

The window assembly 100 may include a frame 104 and one or more sashes (e.g., sash 106 and sash 108) positioned within the frame 104. The frame 104 may be any suitable type of window frame for windows, including but not limited to vinyl frames, aluminum frames, wooden frames, composite frames, fiberglass frames, steel frames, clad frames, or other suitable frames. The frame 104 may include a plurality of frame members (e.g., frame members 112a-d) that are interconnected to define a perimeter around a window and thus an opening for receiving the one or more sashes (e.g., sash 106 and sash 108). The number, size, and arrangement of frame members 112a-d may depend on the desired shape of the frame 104, which may include standard window shapes such as rectangles and squares, as well as non-standard shapes such as arches, circles, trapezoids, or custom configurations. For example, as shown in FIG. 1A, the frame 104 includes four frame members 112a-d that are interconnected to form a conventional rectangular-shaped frame 104 with a rectangular-shaped opening. The rectangular-shaped opening may allow the one or more sashes (e.g., sash 106 and sash 108, both of which are rectangular-shaped) to be positioned within the opening of the frame 104 such that one or more sashes maintain proper coverage of the opening when the window is closed. Nevertheless, it should be appreciated that the frame 104 may be configured in a variety of different ways depending on the particular type of window, and such variations are contemplated within the scope of the present invention.

When the one or more frame members (e.g., frame members 112a-d) are interconnected, each of the one or more frame members (e.g., frame members 112a-d) may include an inner surface configured to be oriented toward the window (e.g., glass panes 110), an outer surface opposing the inner surface, a structure-facing surface configured to be oriented toward a structure (e.g., a shed), and an exterior-facing surface opposing the structure-facing surface and configured to be orientated toward an exterior environment (e.g. a shed exterior).

The size of the frame 104, and thus the size of the plurality of frame members (e.g., frame members 112a-d), may vary depending on factors such as the number and dimensions of the sashes, the type of window, and/or architectural or structural requirements. For example, in some embodiments, the frame 104 may have a length of between about 12 inches and about 72 inches, including but not limited to between about 15 and about 55 inches, between about 20 and about 50 inches, between about 25 and about 45 inches, and between about 30 and about 40 inches. The frame 104 may have a width of between about 12 inches and about 72 inches, including but not limited to between about 15 and about 55 inches, between about 20 and about 50 inches, between about 25 and about 45 inches, and between about 30 and about 40 inches. The frame 104 may have a depth of between about 0.5 inches and about 4 inches, including but not limited to between about 1 inch and about 3.75 inches, between about 1.25 and about 3.5 inches, between about 1.5 and about 3 inches, and between about 2 and about 2.5 inches. Nevertheless, it should be appreciated that the dimensions for the frame 104 may vary significantly depending on the structure and type of window, and other dimensions of the frame 104 are also contemplated within the scope of the present invention.

The one or more sashes (e.g., sash 106 and sash 108) may be positioned within the frame 104 and may be configured to hold respective panes (e.g., glass panes 110) of the window assembly 100. While the panes shown in FIG. 1A are glass panes 110, it should be appreciated that the panes may include any material, including but not limited to acrylic, polycarbonate, fiberglass, composite, or other suitable material. The number, type, and/or arrangement of the one or more sashes may vary depending on the type of window. For example, the window assembly 100 in FIG. 1A is depicted as a horizontal sliding window with two sashes: a fixed sash 106 that is fixably mounted within the frame 104, and a slidable sash 108 that is slidably mounted within the frame 104. The slidable sash 108 may therefore slide horizontally within the frame 104 relative to the fixed sash 106, allowing a user to slide the slidable sash 108 between a closed position (not shown) to an open position (shown in FIG. 1A). The frame 104 may include one or more guides, tracks, channels, or other feature for guiding slidable movement of the slidable sash 108 within the frame. However, it should be appreciated that the window assembly 100 of FIG. 1A is merely intended to illustrate one example, and the frame may include only one sash (e.g., a fixed window with one fixed sash), or may include multiple slidable and/or fixed sashes (e.g., a double-hung window with two slidable sashes, a single-hung window with one slidable sash and one fixed sash), depending on the type of window. Such variations are also contemplated within the scope of the present invention.

For sliding windows (e.g., horizontal sliding windows, hung windows), multiple sashes (e.g., sash 106 and sash 108) may be arranged within the frame 104 in a stacked configuration, with each sash offset and positioned in a separate plane to allow relative movement between the sashes. For example, as shown in FIG. 1A, slidable sash 108 and fixed sash 106 are offset within the frame 104 such that slidable sash 108 is positioned within a plane proximate a structure interior (e.g., a shed interior), while fixed sash 106 is positioned within a plane proximate a structure exterior (e.g., a shed exterior). This arrangement may ensure that slidable sash 108 can move past or overlap fixed sash 106 without interference, while also allowing a user to slide the slidable sash 108 horizontally from within the structure. However, it should be appreciated that other arrangements may be used depending on the desired window configuration, and such arrangements are also contemplated within the scope of the present invention.

The window assembly 100 may include various optional features to facilitate the functionality and/or the operation of the window. For example, for sliding windows, the window assembly 100 may include one or more locking mechanisms (not shown) for securing the position of the slidable sash 108 in a closed position. The one or more locking mechanisms may be any suitable type of locking mechanism, including but not limited to a latch lock, a keyed lock, a bar lock, or other suitable lock. The locking mechanism may be coupled anywhere within the window assembly 100, including but not limited to the slidable sash 108, the frame 104, or other suitable location.

Further, for sliding windows, the window assembly 100 may include one or more handles (not shown) for sliding the slidable sash 108 within the frame 104. The one or more handles may be any suitable type of handle for facilitating sliding movement of the slidable sash 108. For example, the slidable sash 108 may include one or more handles coupled to or integral with a portion of the slidable sash 108 (e.g., a bottom member of the slidable sash 108, or the top member of the slidable sash 108, and/or a side member of the slidable sash 108). For example, the one or more handles may extend along all or part of the respective side (e.g., height and/or width) of the slidable sash 108. The one or more handles may protrude from a face of the slidable sash 108 to provide a user with an easily graspable surface to adjust the position of the slidable sash 108 within the frame 104.

The window assembly 100 may be installed within an opening of a structure (e.g., a shed). To facilitate the installation process, the window assembly may include a mounting flange 114 that may be used to secure the window assembly 100 to the structure during installation. The mounting flange 114 may extend laterally outward from the frame 104, and may extend partially or entirely around the entire perimeter of the frame 104. For example, as shown in FIG. 1A, the mounting flange 114 extends laterally outward from the frame 104 and extends around the entire perimeter of the frame 104, which may facilitate installation of the window assembly 100 to the structure. This may allow the window assembly 100 to be placed into an opening of the structure with the mounting flange 114 overlapping with an exterior surface of the structure (e.g., an exterior sheathing of a shed exterior wall). One or more fastening elements (e.g., fasteners, adhesives) may then be used to secure the mounting flange 114, and thus the window assembly 100, to the exterior surface of the structure.

After the window assembly 100 is installed, siding 130a-c (shown in FIGS. 1D-F) may be secured to the exterior of the structure (e.g., a shed exterior). The siding 130a-c may protect the structure from external elements (e.g., wind, rain, moisture), may provide insulation to improve energy efficiency, and/or may enhance the overall aesthetic appeal of the structure. The siding 130a-c may include siding panels or sheets, which may be cut to fit around the window opening and positioned tightly against the frame 104 to overlap the mounting flange 114. This may conceal the mounting flange 114 and create a seamless appearance. The siding 130a-c may be fastened securely to the structure exterior (e.g., shed exterior wall) using nails, screws, adhesives, or other suitable fastening method depending on the siding material. As will be made apparent by the following disclosure, embodiments of the present invention may allow siding 130a-c to be installed independently, with the J-channel 102 snapped into place afterward, offering greater flexibility in construction.

The siding 130a-c may be any suitable siding and may include, but is not limited to, vinyl siding, wood siding, fiber cement siding, aluminum siding, steel siding, engineered wood siding, brick veneer siding, composite siding, or other suitable siding. The thickness of the siding 130a-c may vary depending on the type of structure, type of siding, design preferences, and/or functional or structural requirements, and may include but is not limited to a thickness of between about 0.25 inches and about 1 inch, such as between about 0.35 inches and about 0.90 inches, between about 0.50 inches and about 0.80 inches, between about 0.60 inches and about 0.75 inches, or between about 0.65 inches and about 0.70 inches. Nevertheless, it should be appreciated that the thickness of the siding 130a-c may vary significantly depending on the type of structure, type of siding 130a-c, design preferences, and/or functional or structural requirements, and other siding 130a-c thicknesses are also contemplated within the scope of the present invention.

FIG. 1B depicts a perspective view of the window assembly 100 of FIG. 1A with the J-channel 102 installed, according to some embodiments of the present invention. As previously explained, the window assembly 100 of FIG. 1 may be installed within an opening of a structure (e.g., a shed), siding 130a-c (shown in FIGS. 1D-F) may be secured to the exterior of the structure (e.g., the shed exterior), and the J-channel 102 may be installed after siding 130a-c is secured to the structure exterior. As will be made apparent by the following disclosure, the J-channel 102 may be removably couplable with the frame 104, which may provide a way of quickly and securely installing the J-channel 102, while also providing the option to remove the J-channel 102 when needed. The J-channel 102 and the frame 104 may include features (e.g., snap-lock protrusions, rachet teeth) that may be spaced or otherwise configured to correspond to variations in siding 130a-c thickness. This may allow the J-channel 102 to be pressed into the frame 104 until the J-channel 102 sits flush with the surrounding siding, thus allowing the J-channel 102 to be adjustable depending on the siding 130a-c thickness. Additionally, because the J-channel 102 is removable, the J-channel 102 may be removed and re-installed to fit siding 130a-c that is thinner or thicker than the original siding 130a-c.

The J-channel 102 may include one or more J-channel members (e.g., J-channel members 116a-d) interconnected to define a perimeter that corresponds to a shape of a window. Thus, each of the one or more J-channel members (e.g., J-channel members 116a-d) may correspond to a respective frame member (e.g., frame members 112a-b), which may facilitate installation of the J-channel 102 to the frame 104.

FIG. 1C depicts a detail view of the frame 104 and the J-channel 102 of the window assembly 100 of FIG. 1B, according to some embodiments of the present invention. In particular, FIG. 1C depicts a detail view of frame members 112a and 112d of the frame 104, and corresponding J-channel members 116a and 116d. However, it should be appreciated that the following description may also apply to one or more of the other frame members (e.g., frame members 112b and 112c) and/or J-channel members (e.g., J-channel members 116b and 116c).

When the one or more J-channel members (e.g., J-channel members 116a-d) are interconnected, each of the one or more J-channel members (e.g., J-channel members 116a-d) may include a structure-facing surface 118 configured to be oriented toward a structure (e.g., a shed), a frame attachment flange 120, and a plurality of engagement features 122 (e.g., snap-lock protrusions). The frame attachment flange 120 may extend from the structure-facing surface 118 and may be generally perpendicular to the structure-facing surface 118. For example, as shown in FIG. 1C, the frame attachment flange 120 extends generally perpendicularly from an inner edge of the structure-facing surface 118 that is proximate the window (e.g., glass panes 110).

The J-channel 102 may include a plurality of engagement features 122 spaced along the frame attachment flange 120. The engagement features 122 may be configured to be received by the plurality of retention features 124 (e.g., rachet teeth) for removable snap-fit coupling of the J-channel 102 to the frame 104. The engagement features 122 may include any feature for engaging with a corresponding feature of the frame 104 (e.g., retention features 124) to create a removable snap-fit coupling between the J-channel 102 and the frame 104, including but not limited to snap lock protrusions (e.g. a hook, a tab, a flange, a ridge, or a combination thereof) or other suitable features. For example, while the J-channel 102 shown in FIG. 1C includes a first hook and a second hook, it should be appreciated that the J-channel may include only one hook or multiple hooks (or other engagement feature(s) 122). Additionally, while the first hook and the second hook may extend from an inner surface of the frame attachment flange 120, with the inner surface of the frame attachment flange 120 configured to be oriented toward the window (e.g., glass panes 110), it should be appreciated that the hooks (or other engagement features 122) may be positioned anywhere on the J-channel to facilitate engagement with the corresponding retention features 124. As shown in FIG. 1C, the first hook may be formed at a structure-facing end of the frame attachment flange 120, with the structure-facing end configured to be oriented toward the structure (e.g., a shed). Thus, the first hook may be formed at a distal end of the frame attachment flange 120. The second hook may disposed proximate the structure-facing surface 118 relative to the first hook.

The frame 104 may include a plurality of retention features 124 spaced on an inner surface and/or an outer surface of one or more of the frame members (e.g., frame members 112a-d). For example, as shown in FIGS. 1A and 1C, each of the frame members 112a-d includes a plurality retention features 124 spaced on an outer surface of the respective frame member. The retention features 124 extend along the entire length of each of the frame members 112a-d such that the retention feature 124 extend around the entire perimeter defined by the plurality of frame members 112a-d. However, it should be appreciated that less than all of the frame members 112a-d may include retention features 124, the retention features 124 may be positioned on other portions of the frame 104 (e.g., an inner surface of a frame member), the retention features 124 may extend along a portion of the length of a frame member, the retention features 124 may extend along a portion of the perimeter defined by the plurality of frame members 112a-d, and/or the retention features 124 may be positioned at discrete locations along the perimeter defined by the plurality of frame members 112a-d.

For example, in some embodiments, the retention features 124 may extend along a portion of the perimeter defined by the plurality of frame members 112a-d and/or may be positioned at discrete locations along the perimeter defined by the plurality of frame members 112a-d. In such embodiments, a corresponding feature of the J-channel 102 (e.g., engagement features 122) may be positioned or otherwise arranged to correspond with that of the retention features 124. For instance, the retention features 124 may extend along between about 5% and about 80% of the perimeter defined by the plurality of frame members 112a-d, including but not limited to between about 10% and about 70% of the perimeter, between about 20% and about 60% of the perimeter, or between about 30% and about 50% of the perimeter, though other ranges and values are also contemplated.

The retention features 124 may include any feature for engaging with a corresponding feature of the J-channel 102 (e.g., engagement features 122) to create a removable snap-fit coupling between the J-channel 102 and the frame 104, including but not limited to teeth, ridges, steps, protrusions, valleys, groves, recesses, or other suitable features. For example, as shown in FIG. 1C, the retention features 124 comprise a plurality of rachet teeth. The rachet teeth may include a series of ridges, steps, or other protrusions (and thus, corresponding valleys, grooves, or other recesses), with each rachet tooth functioning as an individual locking position for the J-channel 102. As shown in FIGS. 1D-F, this may allow the J-channel 102 to be pushed further inward relative to the frame 104 while progressively engaging deeper teeth with the corresponding engagement features 122 (e.g., snap-lock protrusions) of the J-channel 102. The teeth (or other retention features 124) may be angled in the direction of movement to facilitate this process. For instance, when J-channel 102 is pushed inward relative to the frame 104, the corresponding engagement features 122 (e.g., snap-lock protrusions) slide along the sloped surface of the angled tooth, temporarily deflecting or bending to accommodate the motion. Once the engagement features 122 reach a ridge or high point of the tooth, it falls into the valley or recess of the next position, securing the J-channel 102 in that position. This may allow the J-channel 102 to continue moving inward, with each tooth providing a distinct locking position, until the engagement features 122 reach the last tooth defining the innermost position of the J-channel 102. The angle of the teeth (or other retention features 124) may also prevent backward motion of the J-channel 102, as the engagement features 122 cannot easily overcome the steep side of the tooth ridge, thereby maintaining the coupling in the desired position.

The window assembly 100 may include one or more drainage holes (e.g., drainage hole 126) to facilitate the removal of water and prevent accumulation within the frame 104. The drainage hole(s) may be any shape, such as circular, oval, rectangular, or irregular, and may vary in size depending on the specific requirements of the design of the frame 104. The drainage hole(s) may be located on any portion of the frame 104 (and thus frame members 112a-d) and/or the J-channel 102 (and thus J-channel members 116a-d), including the top, bottom, side, inner, or outer surfaces, and may be distributed symmetrically or asymmetrically to optimize drainage efficiency.

In some embodiments, the drainage hole(s) (e.g., drainage hole 126) may be defined by gaps formed at one or more adjacent edges of the frame members 112a-d and/or the J-channel members 116a-d. The frame 104 may include one or more drainage channel flanges 128 extending outwardly from and generally perpendicular to the exterior-facing surface of a respective frame member. For example, as shown in FIG. 1C, the frame includes drainage channel flanges 128 extending outwardly from and generally perpendicular to the exterior-facing surface of a frame member 112a and 112d. Drainage hole 126 is thus at least partially defined by the gap formed at adjacent edges of the frame members 112a and 112d. Additionally, drainage hole 126 may also be at least partially defined by the gap formed at adjacent edges of the J-channel members 116a and 116d. Thus, when the J-channel 102 is installed on the frame 104, the respective gaps formed at adjacent edge of the frame members 112a and 112d and the J-channel members 116a and 116d may define drainage hole 126. It should be appreciated that additional drainage hole(s) may be formed at one or more other adjacent edges of the frame members 112a-d and/or the J-channel members 116a-d.

FIG. 1D-E are cross-sectional views of the frame 104 and the J-channel 102 of the window assembly 100 of FIG. 1B, according to some embodiments of the present invention. In particular, FIGS. 1D-E depict a detail view of frame member 112a of the frame 104 and a corresponding J-channel member 116a. However, it should be appreciated that the following description may also apply to one or more of the other frame members (e.g., frame members 112b-d) and/or J-channel members (e.g., J-channel members 116b-d).

As previously explained, the frame 104 may include one or more drainage channel flanges 128 extending outwardly from and generally perpendicular to the exterior-facing surface of a respective frame member. A drainage channel 132 may be defined by an inner surface of the drainage channel flange 128, at least a portion of the exterior-facing surface of at least one of the plurality of frame members (e.g., frame members 112a-d), and at least a portion of the outer surface of at least one of the plurality of frame members (e.g., frame members 112a-d). For example, as shown in FIGS. 1D-F, a drainage channel 132 is defined by an inner surface of the drainage channel flange 128, a portion of the exterior-facing surface of the frame member 112a, and a portion of the outer surface of outer surface of the frame member 112a. The drainage channel 132 may redirect water away from the window assembly 100 (e.g., towards a drainage hole 126, where excess water may exit the window assembly 100), preventing water accumulation and ensuring proper drainage to protect the window assembly 100 from moisture damage.

The drainage channel 132 may also define a receiving area for the frame attachment flange 120 of the J-channel 102. The drainage channel flange 128 may be positioned to create a controlled clearance based on frame attachment flange 120 or other mating portion of the J-channel 102. This clearance may allow for a secure engagement between the J-channel 102 and frame 104, while also allowing for ease of use. For example, the drainage channel flange 128 may be positioned to allow the frame attachment flange 120 of the J-channel 102 to be inserted and remain engaged with the retention features 124, thus allowing the J-channel 102 to be secured within a desired position. This may also enable the J-channel 102 to be intentionally removed when desired, such as by using manual force or a tool, while also preventing the J-channel 102 from unintentionally disengaging or falling out due to vibrations, movement, gravity, or other factors.

The drainage channel flange 128, the mounting flange 114, and/or other portion of the frame 104 may facilitate the alignment of siding 130a-c relative to the frame 104. For example, as shown in FIGS. 1D-E, the drainage channel flange 128 extends perpendicular to the mounting flange 114. This may allow the drainage channel flange 128 to act as a guide or stop when siding 130a-c is installed around the frame 104 to overlap the mounting flange 114. For instance, after the window assembly 100 is installed within an opening of a structure, siding 130a-c (e.g., siding panels) may be positioned around the frame 104 to overlap the mounting flange 114 and abut the drainage channel flange 128, thus aligning the siding 130a-c relative to the frame 104. The siding 130a-c may then be fastened securely to the structure exterior (e.g., shed exterior wall) using nails, screws, adhesives, or other suitable fastening method depending on the siding material.

The plurality of retention features 124 and the plurality of engagement features 122 may be spaced along one or more surfaces of the respective frame 104 and J-channel 102 to facilitate engagement between the frame 104 and J-channel 102. For example, as shown in FIGS. 1D-F, the retention features 124 are spaced along an outer surface of the frame member 112a, and the engagement features 122 are spaced along an inner surface of the frame attachment flange 120. This may enable the engagement features 122 to interact with the retention features 124 when the J-channel 102 is inserted within the frame 104. However, it should be appreciated that the retention features 124 may be spaced along any other portion of the frame 104, including but not limited to one or more other inner surfaces of the drainage channel 132, and the engagement features 122 may be spaced on any portion of the J-channel, including but not limited to an outer surface of the frame attachment flange 120.

The retention features 124 and/or the engagement features 122 may be spaced to correspond to variations in a siding 130a-c thickness. For example, as shown in FIGS. 1D-F, the frame member 112a may include four rachet teeth, with each rachet tooth spaced to function as an individual locking position for the J-channel 102, while the J-channel 102 includes two hooks that are spaced to allow one or more of the two hooks to engage with a tooth formed in the frame member 112a. However, as explained earlier, the particular number and spacing of engagement features 122 and/or the retention features may vary depending on the type and size of siding 130a-c used and/or the desired functionality of the window assembly 100. Thus, for example, the J-channel 102 may include only one hook or may include more than two hooks depending on the desired functionality.

For example, as shown in FIG. 1D, the siding 130a shown is a relatively thicker siding (e.g., a siding thickness of 1 inch). The J-channel 102 may be inserted within the frame 104 until one or more of the hooks engages with a first tooth and slides along the sloped surface of the tooth. The frame attachment flange 120 may temporarily deflect or bend as the hook(s) slide along the sloped surface of the tooth, until the hook(s) fall into the valley or recess of the next position, securing the J-channel 102 in that position. If necessary, the J-channel 102 may continue to be inserted inwardly within the frame 104, with each tooth providing a distinct locking position, until the hook(s) fall into the valley or recess of the position that secures the relative thicker siding (e.g., a siding thickness of 1 inch). For example, as shown in FIG. 1E, the siding 130b shown is a moderately thick siding (e.g., a siding thickness of 0.5 inches), and thus the J-channel 102 is inserted further within the frame 104 as compared to FIG. 1D. Similarly, as shown in FIG. 1F, the siding 130c shown is a relatively thinner siding (e.g., a siding thickness of 0.25 inches), and thus the J-channel 102 is inserted in the innermost locking position defined by the innermost tooth. It should therefore be appreciated that the number and spacing of retention features 124 and/or the engagement features 122 may be reconfigured depending on the type and size of siding 130a-c used and/or the desired functionality of the window assembly 100.

One or more of the plurality of J-channel members 116a-d may include a siding cover flange 134. The siding cover flange 134 may provide certain benefits, such as securely covering and/or the edges of the siding 130a-c when the J-channel 102 is installed, improving the aesthetic appeal of the installation, helping to channel water away from the siding and window, reducing the risk of moisture infiltration and enhancing weather resistance, and/or creating a tight seal and supporting the siding edges. For example, as shown in FIG. 1B, the siding cover flange 134 may extend along an entire length of each of the J-channel members 116a-d, such that the siding cover flange 134 extends around the perimeter of the window assembly 100. However, it should be appreciated that less than all of the J-channel members 116a-d may include a siding cover flange 134, and/or the siding cover flange may extend along a portion of the length of a J-channel member and/or around a portion of the perimeter of the window assembly 100.

The siding cover flange 134 may be configured to facilitate in securing the siding 130a-c between the J-channel 102 and the frame 104. For example, as shown in FIGS. 1D-F, the siding cover flange 134 may extend perpendicular to the frame attachment flange 120. Thus, when the J-channel 102 is inserted within the frame 104, the siding 130a-c may be secured between the siding cover flange 134 and the mounting flange 114 of the frame 104. The siding cover flange 134 may also be configured to flex during installation and contract to securely retain the siding 130a-c between the siding cover flange 134 and the frame 104. For example, as shown in FIGS. 1D-F, the siding cover flange 134 may be at least partially curved to apply an inward force on the siding 130a-c when the J-channel 102 is fully inserted within the frame 104. This inward force may further secure the siding 130 and create a tight seal around the siding 130a-c, which may improve the aesthetic appeal and/or functionality of the window assembly 100.

The methods, systems, and devices discussed above are examples. Some embodiments were described as processes depicted as flow diagrams or block diagrams. Although each may describe the operations as a sequential process, many of the operations can be performed in parallel or concurrently. In addition, the order of the operations may be rearranged. A process may have additional steps not included in the figure. It will be further appreciated that all testing methods described here may be based on the testing standards in use at the time of filing or those developed after filing.

Having disclosed several embodiments, it will be recognized by those of skill in the art that various modifications, alternative constructions, and equivalents may be used without departing from the spirit of the embodiments. Additionally, a number of well-known processes and elements have not been described in order to avoid unnecessarily obscuring the present technology. Accordingly, the above description should not be taken as limiting the scope of the technology.

As used herein and in the following claims, the singular forms “a”, “an”, and “the” include plural references unless the context clearly dictates otherwise. Thus, for example, reference to “an element” includes a plurality of such elements, and reference to “the aperture” includes reference to one or more apertures and equivalents thereof known to those skilled in the art, and so forth.

Further, as used herein and in the following claims, the term “generally” is used to describe a characteristic, relationship, or condition that is broadly applicable or approximate, without requiring absolute precision or exact conformity unless explicitly stated. The term is intended to encompass reasonable variations or deviations while still reflecting the overall essence or intended scope of the described feature, structure, or relationship. For example, “generally” may refer to shapes, orientations, or alignments that deviate by a range of ±20% from a specified description, depending on the context and functional requirements.

Further, as used herein and in the following claims, the term “proximate” is intended to encompass both being at a particular location and being near or in close proximity to a particular location. It should therefore be appreciated that the specific meaning of “proximate” may vary depending on the context of the invention, and it is not limited to an exact location unless explicitly stated. For example, “proximate” may refer to a location within a defined range, such as within a few millimeters, centimeters, or meters in physical distance, or within a defined percentage range of a particular parameter. By way of illustration, “proximate” may include being within ±20% of a specified distance or measurement, depending on the application. Such ranges are provided as examples and should not be considered limiting unless explicitly stated. The scope of “proximate” should be understood in accordance with the principles and objectives of the invention as described herein.

Further, as used herein and in the following claims, the words “comprise(s)”, “comprising”, “contain(s)”, “containing”, “include(s)”, and “including” are intended to specify the presence of stated features, integers, components, or operations, but they do not preclude the presence or addition of one or more other features, integers, components, operations, acts, or groups.

What is claimed is:

1. A window assembly, comprising:
a frame comprising:
a plurality of frame members interconnected to define a perimeter around a window, each of the plurality of frame members comprising:
an inner surface configured to be oriented toward the window;
an outer surface opposing the inner surface;
a structure-facing surface configured to be oriented toward a structure; and
an exterior-facing surface opposing the structure-facing surface and configured to be orientated toward an exterior environment;
a plurality of retention features spaced along at least one of the inner surface or the outer surface of at least one of the plurality of frame members; and
a J-channel removably couplable to the frame, the J-channel comprising:
a structure-facing surface configured to be oriented toward the structure;
a frame attachment flange extending from and generally perpendicular to the structure-facing surface; and
a plurality of engagement features spaced along the frame attachment flange, wherein the plurality of engagement features are configured to be received by the plurality of retention features for removable snap-fit coupling of the J-channel to the frame.

2. The window assembly of claim 1, wherein:
spacing of the plurality of retention features corresponds to variations in a siding thickness.

3. The window assembly of claim 1, wherein:
the frame further comprises:
a drainage channel flange extending outwardly from and generally perpendicular to the exterior-facing surface of at least one of the plurality of frame members; and
a drainage channel defined by an inner surface of the drainage channel flange, at least a portion of the exterior-facing surface of at least one of the plurality of frame members, and at least a portion of the outer surface of at least one of the plurality of frame members; and
the plurality of retention features are spaced along an inner surface of the drainage channel.

4. The window assembly of claim 3, wherein:
the frame further comprises at least one drainage hole formed in the drainage channel flange of at least one of the plurality of frame members.

5. The window assembly of claim 1, wherein:
the plurality of retention features are spaced along at least a portion of the outer surface of at least one of the plurality of frame members, and the plurality of engagement features are spaced along at least a portion of an inner surface of the frame attachment flange, the inner surface of the frame attachment flange configured to be oriented toward the window.

6. The window assembly of claim 1, wherein:
the plurality of engagement features comprise a plurality of hooks.

7. The window assembly of claim 1, wherein:
the plurality of retention features comprise rachet teeth.

8. The window assembly of claim 1, wherein:
the frame attachment flange of the J-channel extends from an inner edge of the structure-facing surface, the inner edge of the structure-facing surface configured to be proximate the window.

9. The window assembly of claim 8, wherein:
the frame attachment flange of the J-channel extends along a portion of the inner edge of the structure-facing surface.

10. The window assembly of claim 8, wherein:
the plurality of engagement features comprise a first hook and a second hook, wherein the first hook is formed at a structure-facing end of the frame attachment flange, the structure-facing end configured to be oriented toward the structure, and the second hook is disposed on an inner surface of the frame attachment flange, the inner surface of the frame attachment flange configured to be oriented toward the window.

11. The window assembly of claim 1, wherein:
the frame comprises a plurality of drainage channel flanges, each of the plurality of drainage channel flanges extending outwardly from and generally perpendicular to the exterior-facing surface of a corresponding frame member of the plurality of frame members, the plurality of drainage channel flanges being arranged to correspond to a shape of the perimeter; and
a drainage channel is defined by an inner surface of the plurality of drainage channel flanges, at least a portion of the exterior-facing surface of the plurality of frame members, and at least a portion of the outer surface of the plurality of frame members.

12. The window assembly of claim 11, wherein:
adjacent ends of the plurality of drainage channel flanges at respective corners of the frame are spaced to form a plurality of gaps, each of the plurality of gaps at least partially defining a drainage hole.

13. A J-channel for a window, comprising:
a plurality of J-channel members interconnected to define a perimeter that corresponds to a shape of a window, each of the plurality of J-channel members comprising:
a structure-facing surface configured to be oriented toward a structure;
a frame attachment flange extending from an inner edge of the structure-facing surface and in a generally perpendicular direction relative to the structure-facing surface, the inner edge of the structure-facing surface configured to be proximate the window; and
a plurality of snap-lock protrusions spaced along an inner surface of the frame attachment flange, the inner surface of the frame attachment flange configured to be oriented towards the window, wherein the plurality of snap-lock protrusions are configured to be received by a frame of the window for removable snap-fit coupling of the J-channel to the frame.

14. The J-channel of claim 13, wherein:
spacing of the plurality of snap-lock protrusions on the inner surface of the frame attachment flange corresponds to variations in a siding thickness.

15. The J-channel of claim 13, wherein:
the plurality of snap-lock protrusions comprise at least one of a hook, a tab, a flange, a ridge, or a combination thereof.

16. The J-channel of claim 13, wherein:
the frame attachment flange extends along a portion of the inner edge of the structure-facing surface.

17. The J-channel of claim 13, wherein:
adjacent ends of the frame attachment flange of the plurality of J-channel members are spaced to form a plurality of gaps, each of the plurality of gaps at least partially defining a drainage hole.

18. The J-channel of claim 13, wherein:
the plurality of snap-lock protrusions comprise a first hook and a second hook, wherein the first hook is formed at a structure-facing end of the frame attachment flange, the structure-facing end configured to be oriented toward the structure, and the second hook is disposed on the inner surface of the frame attachment flange.

19. The J-channel of claim 13, wherein:
each of the plurality of J-channel members further comprises a siding cover flange, wherein the siding cover flange comprises the structure-facing surface and the inner edge.

20. The J-channel of claim 19, wherein:
the siding cover flange is configured to secure and at least partially cover siding positioned between the structure-facing surface and the frame.

21. The J-channel of claim 19, wherein:
the siding cover flange is configured to flex during siding installation and contract to securely retain siding positioned between the structure-facing surface and the frame.

22. A frame for a window, comprising:
a plurality of frame members interconnected to define a perimeter around a window, each of the plurality of frame members comprising:
an inner surface configured to be oriented toward the window;
an outer surface opposing the inner surface;
a structure-facing surface configured to be oriented toward a structure; and
an exterior-facing surface opposing the structure-facing surface and configured to be orientated toward an exterior environment; and
a plurality of retention features spaced along at least one of the inner surface or the outer surface of at least one of the plurality of frame members.

23. The frame of claim 22, wherein:
spacing of the plurality of retention features corresponds to variations in a siding thickness.

24. The frame of claim 22, further comprising:
a drainage channel flange extending outwardly from and generally perpendicular to the exterior-facing surface of at least one of the plurality of frame members; and
a drainage channel defined by an inner surface of the drainage channel flange, at least a portion of the exterior-facing surface of at least one of the plurality of frame members, and at least a portion of the outer surface of at least one of the plurality of frame members, wherein the plurality of retention features are spaced along an inner surface of the drainage channel.

25. The frame of claim 22, further comprising:
at least one drainage hole formed in at least one of the plurality of frame members.

26. The frame of claim 22, wherein:
the plurality of retention features comprise rachet teeth.

27. The frame of claim 22, wherein:
the frame comprises a plurality of drainage channel flanges, each of the plurality of drainage channel flanges extending outwardly from and generally perpendicular to the exterior-facing surface of a corresponding frame member of the plurality of frame members, the plurality of drainage channel flanges being arranged to correspond to a shape of the perimeter; and
a drainage channel is defined by an inner surface of the plurality of drainage channel flanges, at least a portion of the exterior-facing surface of the plurality of frame members, and at least a portion of the outer surface of the plurality of frame members.

28. The frame of claim 27, wherein:
adjacent ends of the plurality of drainage channel flanges at respective corners of the frame are spaced to form a plurality of gaps, each of the plurality of gaps at least partially defining a drainage hole.
